(19) United States
(12) Patent Application Publication
(10) Pub. No.: US 2013/0144661 A1
(43) Pub. Date: Jun. 6, 2013

(54) METHOD AND SYSTEM FOR PREPARING AND CONDUCTING PROMOTIONAL PRESENTATIONS AT GEOGRAPHICALLY REMOTE LOCATIONS

(71) Applicants: Robert Turley, Overland Park, KS (US); Peter Reininga, Leawood, KS (US)

(72) Inventors: Robert Turley, Overland Park, KS (US); Peter Reininga, Leawood, KS (US)

(73) Assignee: DENNIS GARBERG AND ASSOCIATES, INC., Lenexa, KS (US)

(21) Appl. No.: 13/312,909

(22) Filed: Dec. 6, 2011

(51) Int. Cl. G06Q 10/02

(52) U.S. Cl. 705/5

(57) ABSTRACT

A computer program, method, and system for organizing and conducting product or service demonstrations may be implemented with a computer system operated by or for an agent or other person or entity that organizes product or service demonstrations and a plurality of mobile phones or other portable electronic devices operated by event personnel or other persons who staff or otherwise run the product or service demonstrations. Each mobile phone may be provisioned with an event management program that receives information and data from the computer system, provides instructions and other information to an event personnel using the mobile phone, receives inputs from the event personnel while a product or service demonstration is being performed, and transmits information and data back to the computer system.

### BACKGROUND

The present invention relates to product and service demonstrations and other similar events. More particularly, the invention relates to a computer program, method, and system for preparing and conducting product and service demonstrations and other events.

Product manufacturers and service providers often wish to demonstrate their products and services for promotional purposes. For example, food manufactures often give away product samples for taste testings; device manufactures often provide product demonstrations to educate consumers about their devices; and service providers often hand-out informational brochures and other information to explain and promote their services. The demonstrations are typically conducted in stores but may be conducted anywhere that consumers frequently shop or gather.

Product and service demonstrations are typically organized by independent agents that provide similar services to multiple product manufactures or service providers. The agents then hire one or more event personnel who set-up and run the demonstrations. The demonstrations may also be organized and run by employees of the product manufacturers or service providers or even the stores at which the events are held.

Many product manufacturers, service providers, and/or agents often prepare and organize numerous demonstrations that occur simultaneously at numerous different locations. Similarly, many event personnel often staff multiple demonstration events every week. Thus, the product manufacturers, service providers, agents, and event personnel must accumulate and keep track of a significant amount of information. Various different systems and methods have been developed to assist with these tasks, but they all suffer from distinct limitations.

### SUMMARY

The present invention solves the above-described problems and provides a distinct advance in the art of organizing, preparing, staffing, and conducting product and service demonstrations and other events. More particularly, the present invention provides a computer program, method, and system that simplify and improve the organizing, preparing, staffing, and conducting of product or service demonstrations and that provide valuable status information to all those involved in such demonstrations.

An embodiment of the invention may be implemented with a computer system operated by or for an agent or other person or entity that organizes product or service demonstrations and a plurality of mobile phones or other portable electronic devices operated by event personnel or other persons who staff or otherwise run the product or service demonstrations. The computer system may store information about all the events being handled by the event agent and information about all the event personnel who have worked with the event agent.

Each event personnel may have an account stored on the computer system that lists all the upcoming events the event personnel has agreed to staff. The account may also store information about events for which the event personnel has not yet registered and past events. This information ay also be stored in resident memory of the mobile phone.

Each mobile phone may be provisioned with an event management program that receives information and data from the computer system, provides instructions and other information to the event personnel using the mobile phone, receives inputs from the event personnel while a product or service demonstration is being performed, and transmits information and data back to the computer system. The event personnel may use the event management program to display the list of events and check into one by selecting a button on the phone's screen. After the event personnel checks in, the computer system may send additional details about the event to the mobile phone.

After the event personnel checks in to an event, the event management program may determine the location of the mobile phone and compare it to the event's scheduled location to confirm that the event personnel is at the right store. Alternatively, the event management program may transmit the location data to the remote computer system so the computer system and/or the agent operating the computer system may confirm that the event personnel is in the right place. Location data may also be periodically gathered by the event management program and sent to the computer system during the event to confirm the event personnel doesn't leave the event before it is over.

Sales goal data for an event may also be entered into the computer system, and such data may be transmitted from the computer system to the event personnels' mobile phones. The event management program of each mobile phone then displays the sales goal data to the event personnel. The event management program may also allow the event personnel to manually input actual sales data for the event, and this information may be displayed alongside the sales goals. The actual sales data may also be uploaded to the computer system and broadcast to other event personnel to create competition between the event personnel.

This summary is provided to introduce a selection of concepts in a simplified form that are further described in the detailed description below. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a block diagram that illustrates persons and/or entities that may use aspects of the present invention.

FIG. 2 is a schematic diagram of exemplary computer and communications equipment that may be used to implement embodiments of the invention.

FIG. 3 is a flow diagram illustrating steps in a method of the invention and/or code segments in a computer program of the invention.

FIG. 4 is an exemplary screen display that may be presented by one or more computer programs of the present invention.

FIG. 5 is another exemplary screen display that may be presented by the computer programs of the present invention.

FIG. 6 is another exemplary screen display that may be presented by the computer programs of the present invention.

FIG. 7 is another exemplary screen display that may be presented by the computer programs of the present invention.

FIG. 8 is another exemplary screen display that may be presented by the computer programs of the present invention.

FIG. 9 is another exemplary screen display that may be presented by the computer programs of the present invention.

FIG. 10 is another exemplary screen display that may be presented by the computer programs of the present invention.

FIG. 11 is another exemplary screen display that may be presented by the computer programs of the present invention.

FIG. 12 is another exemplary screen display that may be presented by the computer programs of the present invention.

FIG. 13 is another exemplary screen display that may be presented by the computer programs of the present invention.

FIG. 14 is another exemplary screen display that may be presented by the computer programs of the present invention.

FIG. 15 is another exemplary screen display that may be presented by the computer programs of the present invention.

FIG. 16 is another exemplary screen display that may be presented by the computer programs of the present invention.

FIG. 17 is another exemplary screen display that may be presented by the computer programs of the present invention.

FIG. 18 is another exemplary screen display that may be presented by the computer programs of the present invention.

FIG. 19 is another exemplary screen display that may be presented by the computer programs of the present invention.

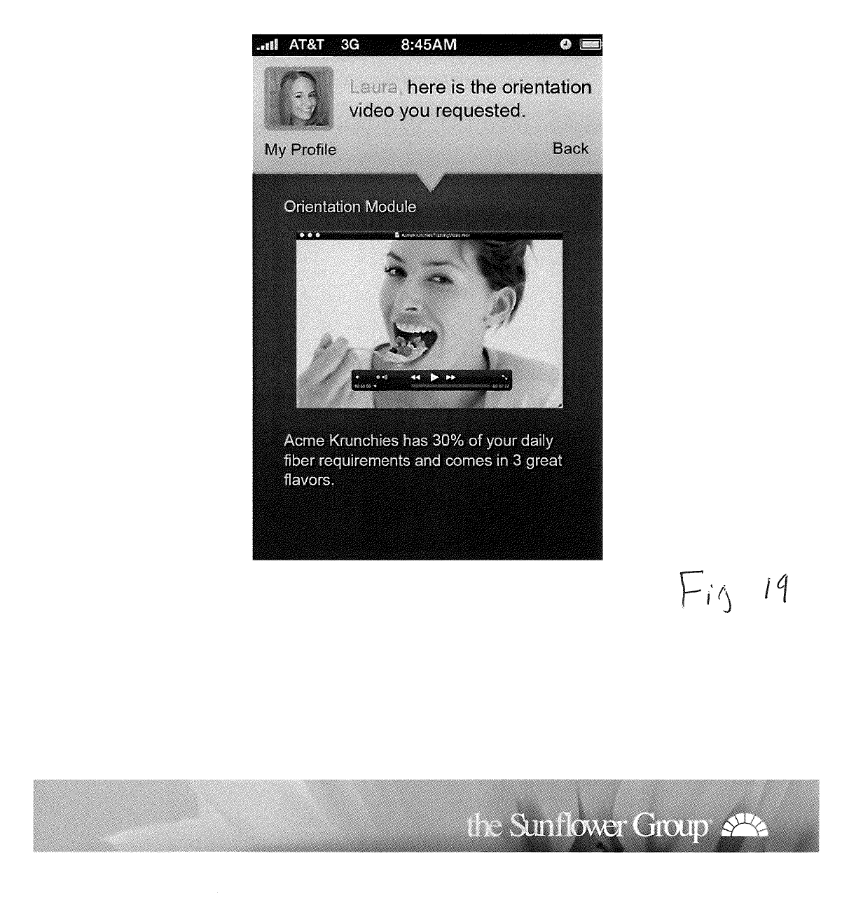

FIG. 20 is another exemplary screen display that may be presented by the computer programs of the present invention.

FIG. 21 is another exemplary screen display that may be presented by the computer programs of the present invention.

FIG. 22 is another exemplary screen display that may be presented by the computer programs of the present invention.

FIG. 23 is another exemplary screen display that may be presented by the computer programs of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION

The following detailed description of embodiments of the invention references the accompanying drawings. The embodiments are intended to describe aspects of the invention in sufficient detail to enable those skilled in the art to practice the invention. Other embodiments can be utilized and changes can be made without departing from the scope of the claims. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, act, etc. described in one embodiment may also be included in other embodiments, but is not necessarily included. Thus, the present technology can include a variety of combinations and/or integrations of the embodiments described herein.

The present invention provides various embodiments of a computer program, method, and system for organizing, preparing, staffing, and conducting events. As used herein, “events” or “event” may include product or service demonstrations, taste tests, light merchandising tasks (where coupons, labels, etc. are attached to products on a store's shelves and/or several products are bundled together), store audits (secret shoppers), or any other events or tasks in which products, services and other things are demonstrated, sold, or otherwise handled.

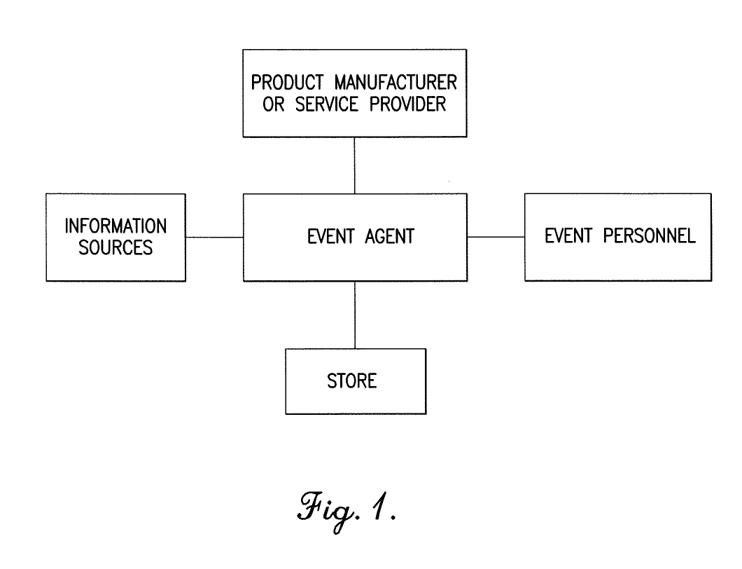

FIG. 1 is a block diagram that illustrates the relationships between persons and/or entities that may be involved in planning, coordinating, and/or running an event. The entities include a product manufacturer or service provider, an event agent, one ore more event personnel, and a store.

The product manufacturer may be a manufacturer, producer, or a grower of food products such as dairy products, meat products, produce, packaged goods, etc. or may be a manufacturer of devices such as mops, electronic devices, games, etc. The service provider may be a bank, insurance company, travel agency, transportation company, car rental agency, real estate agency, an Internet service provider, etc.

The event agent can be any entity or person that provides product or service demonstration services or similar services. The event agent may be an independent organization or may be owned by the product manufacturer, service provider, or even the store. In one embodiment, the event agent may be a promotional services firm such as the Sunflower Group of Lenexa, Kans. As illustrated in FIG. 1, the event agent may receive data from and provide data to third party information sources such as employment agencies, governmental agencies, etc.

The event personnel may be any individual or individuals that staff or otherwise help run a product or service demonstration or other event. The event personnel may be independent contractors or may be employees of the event agent, the product manufacturer, the service provider, or even the store.

The store may be a grocery store, warehouse store, or discount store, shopping mall, farmers market, or any other establishment or location where customers shop or otherwise gather. The store may even be a booth, stall, or other structure set-up in a parking lot, stadium, or other location.

The product manufacturer, service provider, event agent, event personnel, and the store may be one entity or a plurality of entities. For example, employees of the product manufacturer can provide the services of the event agent and/or event personnel. In one embodiment, the product manufacturer or service provider contacts the event agent to request a demonstration of a particular product or service at the store. The event agent then finds the event personnel to staff the event at the store.

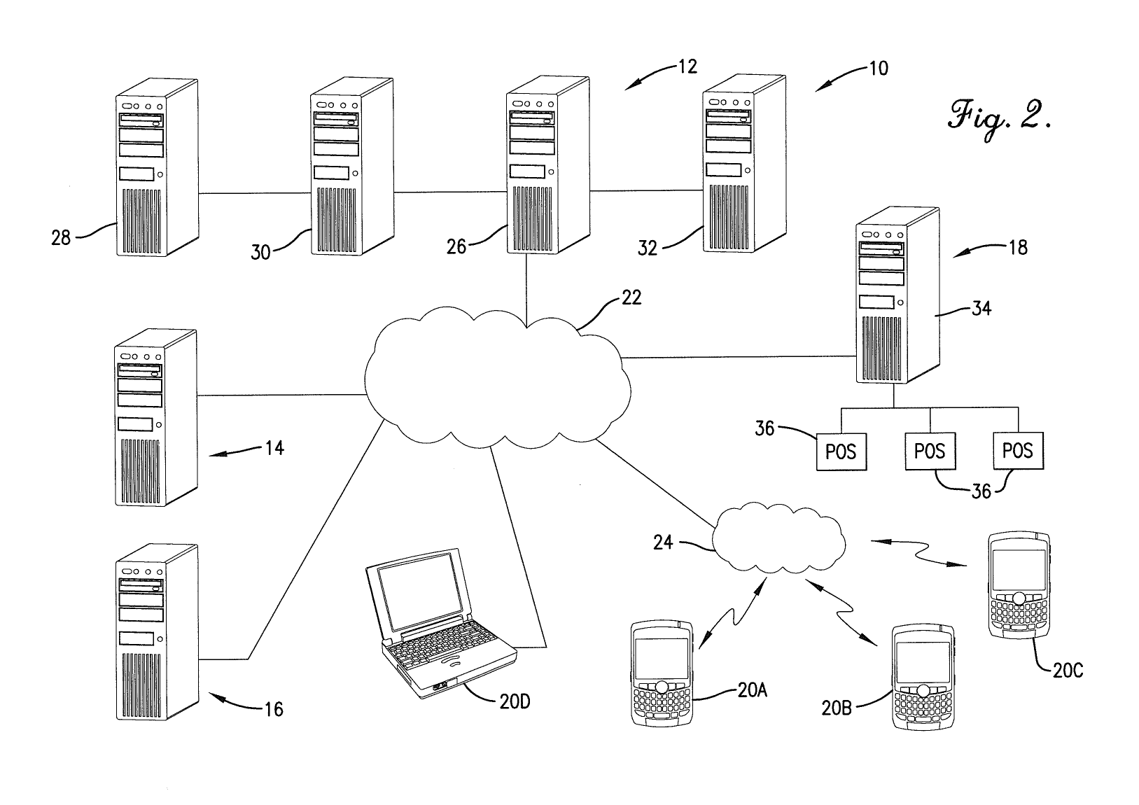

Aspects of the invention can be implemented with computer hardware, software, firmware, or a combination thereof In one embodiment, aspects of the invention may be at least partially implemented with a system of computer and communications equipment broadly referred to by the numeral 10 in FIG. 2. An embodiment of the computer and communications equipment 10 includes a computer system 12 operated by or for the event agent, one or more computer systems 14, 16 operated by the product manufacturers or service providers, a point of sale computer system 18 operated by or for the store, one or more portable electronic devices 20A, 20B, 20C, 20D operated by event personnel, a communications network 22, and a wireless telecommunications network 24. The components of the computer and communication equipment 10 illustrated and described herein are merely examples of equipment that may be used to implement embodiments of the present invention and may be replaced with other equipment without departing from the scope of the present invention.

In more detail, the computer system 12 stores or access data and other information that may be used by an event agent or other person or entity to organize, prepare, staff, and/or conduct product or service demonstrations or other events. The computer system 12 may also implement one or more computer programs for performing some of the functions described herein. The computer system 12 may also provide a web-based portal that can be accessed by the portable electronic devices operated by the event personnel and others.

Embodiments of the computer system 12 may include one or more servers running Windows; LAMP (Linux, Apache HTTP server, MySQL, and PHP/Perl/Python); Java; AJAX; NT; Novel Netware; Unix; or any other software system. The computer system includes or has access to computer memory and other hardware and software for receiving, storing, accessing, and transmitting information as described below. The computer system 12 also includes conventional web hosting operating software, searching algorithms, an Internet connection, and is assigned a URL and corresponding domain name such as “eventapp.com” so that it can be accessed via the Internet in a conventional manner.

One particular embodiment of the computer system 12 may comprise a web server 26, a database server 28, an application server 30, and/or an FTP server 32. The number and type of servers in the computer system 12 is a matter of design choice and may depend on the number of events handled by the event agent and the number of requests and other queries received by the computer system 12. Thus, the invention is not limited to the specific servers and other equipment described and illustrated herein.

The database server 28 or another server may host or otherwise store an in-store information system (ISIS) that includes details of all the stores, events, products, services, and event displays handled by the event agent. This database may be populated by the product manufacturer, service provider, event agent, or even the store.

The database server 28 may also host or store a database of people who wish to be event personnel. This database may include the names, addresses, age, sex, employment history, skills, etc. of all the event personnel. This information may be uploaded to the database server 28 by the event personnel through an on-line interview process or may be manually entered by the event agent or other person. In one embodiment, this database is categorized or otherwise segregated by the personnel's skill set such that all personnel who have skills in a particular field (sports, cooking, finance, etc.) are grouped together or otherwise identifiable by the skill.

The database server 28 may also store an account created by or for each event personnel. Each account may store personal information about the event personnel as sell as information about the events the event personnel has been invited to staff, agreed to staff, and/or already staffed as described in more detail below.

The application server 30 or one of the other servers may host and support software and services of proprietary mobile application providers such as Google, Apple, and Blackberry. This server may store the event management program that is loaded on the portable electronic devices 20A-D as described in more detail below.

The computer systems 14, 16 may be operated by one or more product manufacturers or service providers that hire the event agent to handle an event. For example, the systems 14, 16 may be operated by a food grower, producer or manufacturer; a restaurant; a bank, or any other entity that sells products or provides services. Each computer system 14, 16 may comprise any number of servers or other equipment that provides data to and receives data from the computer system 12 via the communications network 22 or any other network. Although only two product manufacturer or service provider computer systems 14, 16 are shown in FIG. 2, it is understood that any number of such systems may interact with the computer system 12.

The computer system 18 is operated by the store at which a demonstration is held and may be any system used by the store to track sales of products and services in the store. An exemplary point of sale system 18 may include one or more central servers 34 or other computers and a plurality of distributed point of sale terminals or registers 36 as illustrated. In some embodiments of the invention, the point of sale system 18 provides information to and receives information from the computer system 12 via the communications network 22 or another network. For example, as described below, the point of sale system 18 may provide the computer system 12 sales data for products or services sold in the store during and/or immediately after a product demonstration or other event.

The portable electronic devices 20A-D may be any devices used by event personnel and others to access the computer system 12 via the communications network 22, the wireless network 24, and/or any other network. For example, the portable electronic devices may be mobile phones or similar devices that can make and receive wireless communications such as phone calls, SMS texts, MMS messages, SMTP messages, etc. via the wireless telecommunication network 24. The portable electronic devices may also include phone-enabled personal digital assistants, phone-enabled MP3 devices, phone-enabled handheld game players, phone-enabled tablet computers, or any other wireless communication devices. In some embodiments, the portable electronic devices are “smart” phones such as those manufactured by Apple®, Blackberry®, or Motorola®. The portable electronic devices may also be laptop computers, tablet computers, handheld gaming devices or other portable personal computers that include mobile phones or other wireless communication devices. Each portable electronic device preferably includes or can access an Internet browser and a conventional Internet connection such as a wireless broadband connection, a modem, DSL converter, or ISDN converter so that it can access the central registry 12 via the communications network 24. Each mobile communication device also includes a global navigation system receiver such as a GPS receiver.

The communications network 22 is preferably the Internet but may be any other communications network such as a local area network, a wide area network, or an intranet. The wireless network 24 may be any network capable of supporting wireless communications such as the wireless networks operated by AT&T, Verizon, or Sprint. The wireless network may include conventional switching and routing equipment. The communications network 22 and wireless network 24 may also be combined or implemented with several different networks.

Embodiments in the present invention also comprise one or more computer programs stored in or on computer-readable medium residing on or accessible by the computer system 12, the portable electronic devices 20A-D, or other computer equipment. The computer programs may comprise listings of executable instructions for implementing logical functions in the computer equipment. The computer programs can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any non-transitory means that can contain, store, or communicate the programs. The computer-readable medium can be, for example, but not limited to, an electronic, magnetic, optical, electro-magnetic, infrared, or semi-conductor system, apparatus, or device. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

One embodiment of the invention includes one or more computer programs that implement functions and features of the invention on the computer system 12 and an event management program that may be loaded on some or all of the portable electronic devices 20A-D for implementing functions and features of the invention on the devices.

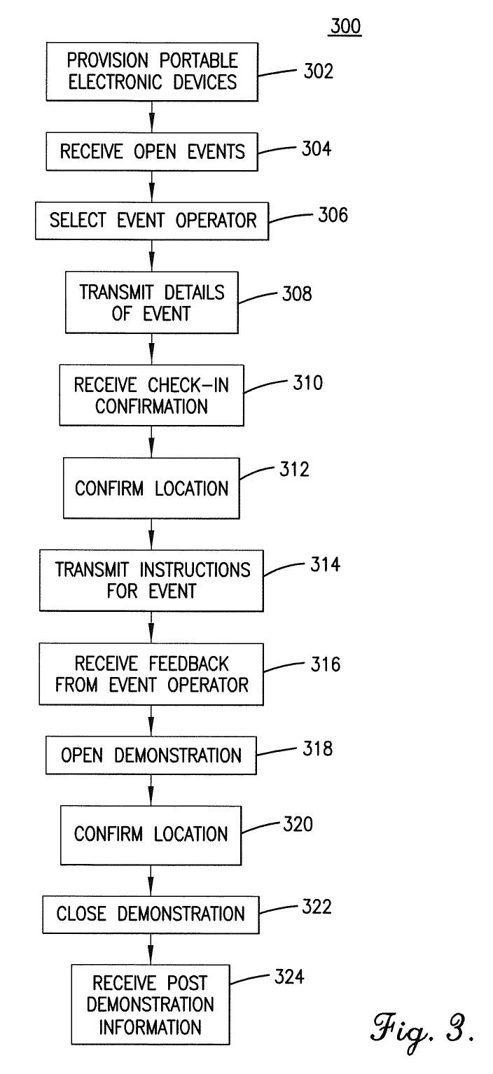

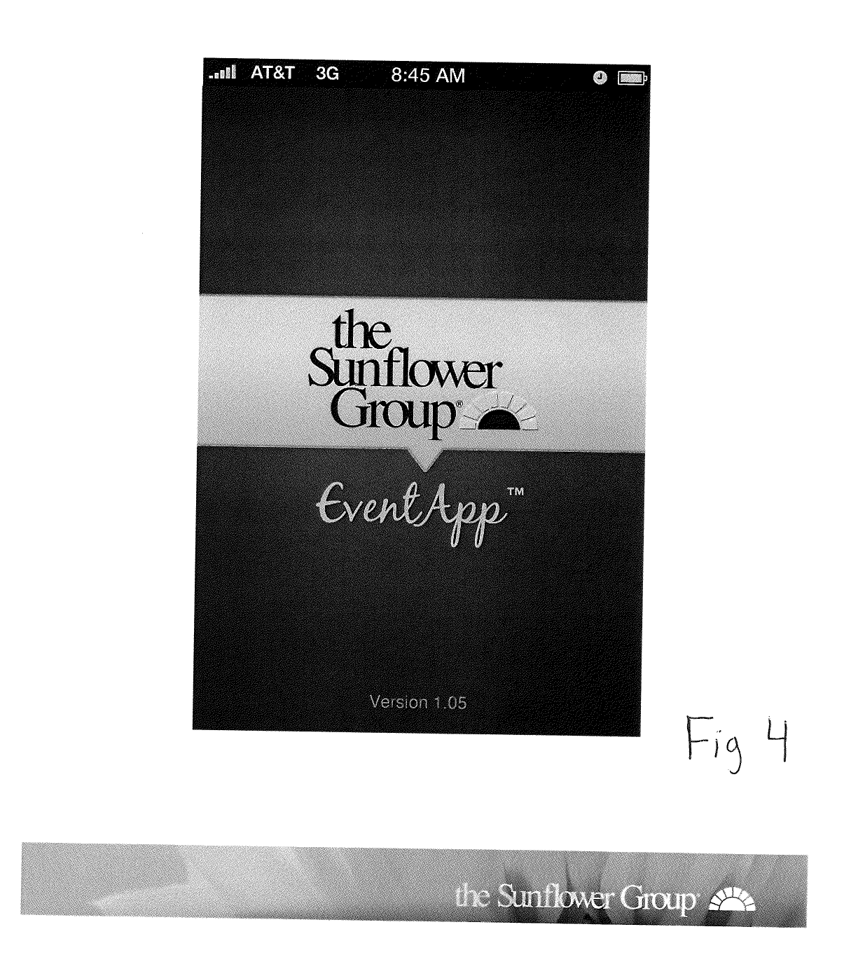

The flow chart of FIG. 3 shows the functionality and operation of an exemplary implementation of the present invention in more detail. In this regard, some of the blocks of the flow chart may represent a module segment or portion of code of the computer programs of the present invention. The computer programs may comprise one or more executable instructions for implementing the specified logical function or functions. In some alternative implementations, the functions noted in the various blocks may occur out of the order depicted in FIG. 3. For example, two blocks shown in succession in FIG. 3 may in fact be executed substantially concurrently, or the blocks may sometimes be executed in the reverse order depending upon the functionality involved. Some of the module segments or code of the computer programs may display, populate, or otherwise enable the screen displays shown in FIGS. 4-17.

A method of the present invention may being when one or more of the portable electronic devices 20A-D are provisioned with the event management software as depicted in step 302. This may be done in any conventional manner. For example, the portable electronic devices may be pre-loaded with the software or a user may access the computer system 12 or another computing device associated with the system to download the software. Each user may then create an account that will be stored on the computer system 12 or another computer system.

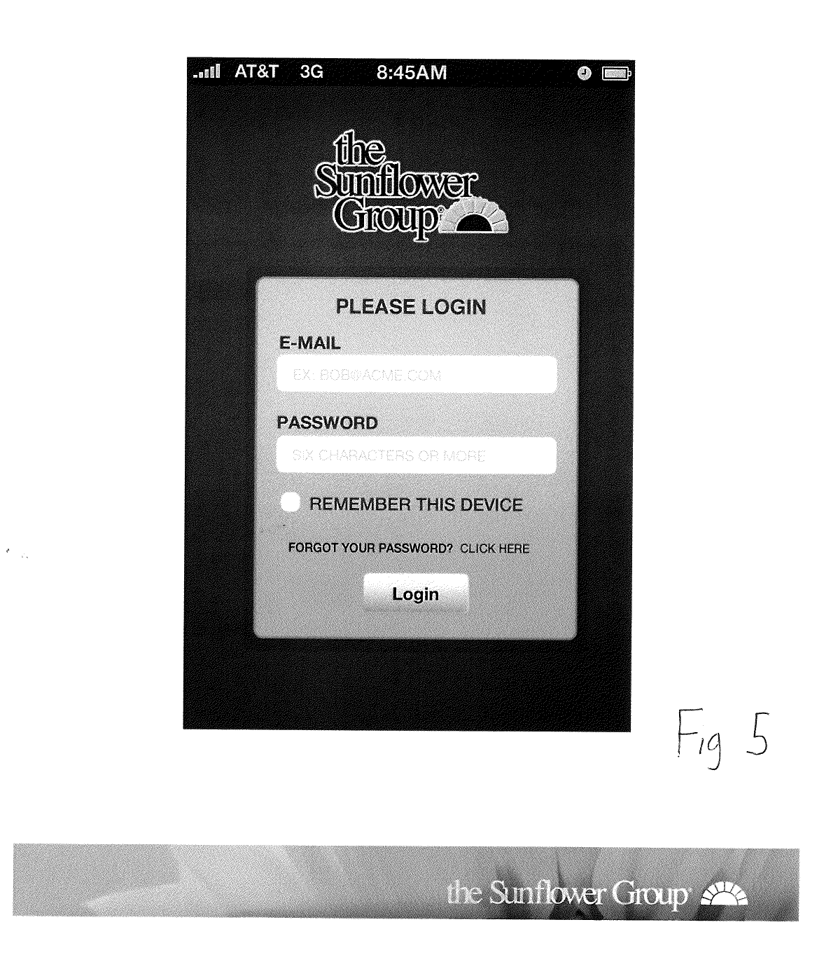

Once a portable electronic device is provisioned with the software and the user has created an account, a user may open the software and interact with the computer system 12 as described herein. FIG. 4 shows an exemplary introductory or “splash” page that may be displayed when the software is first opened. When opened, the software may establish communications with the computer system 12 and display a log-in screen as shown in FIG. 5.

In step 304, the event agent or other person organizing an event receives an order for a product or service demonstration or other event from the product manufacturer or service provider. The order may include details of the event such as its location, date, and time; information about the product or service to be demonstrated; and details about how the product or service should be demonstrated. The event order, and the related information, may be sent to the event agent in any conventional manner and stored in the computer system 12.

Once the event agent has received an event order, the event agent must select one or more event personnel to run or otherwise staff the event as depicted in step 306. This task may be done in a variety of manners. In one embodiment, the event agent may access the database of event personnel stored on the database server 28 and manually or automatically search for suitable event personnel. The event agent may then simply call or e-mail the selected event personnel and schedule them for the event.

In another embodiment, the event management software on the portable electronic devices 20A-D is used to assist with the selection of event personnel. For example, the event agent may access the database server 28 and identify event personnel that are within a specified distance (e.g. 10 miles) of the store at which the event will be held. The event agent may also search for event personnel with particular skills. For example, if the event requires food preparations, the event agent may search for event personnel with cooking experience. The event agent may then use the computer system 12 to broadcast a summary of the event, such as its date and location, and information about the product or services being demonstrated, to the portable electronic devices 20A-D of the identified event personnel. Each event personnel may then view the summary of the event on his or her portable electronic device and indicate whether they wish to staff the event. The computer system 12 receives the messages from the portable electronic devices 20A-D and may present a list of available event personnel to the event agent. The event agent may then manually or automatically select which of the event personnel to hire and may then notify them via their portable electronic devices.

In yet another embodiment, the event personnel may be selected in the same manner as described in the previous paragraph except that the first event personnel (or the first specified number of event personnel if more than one is required) that accepts the event is automatically chosen.

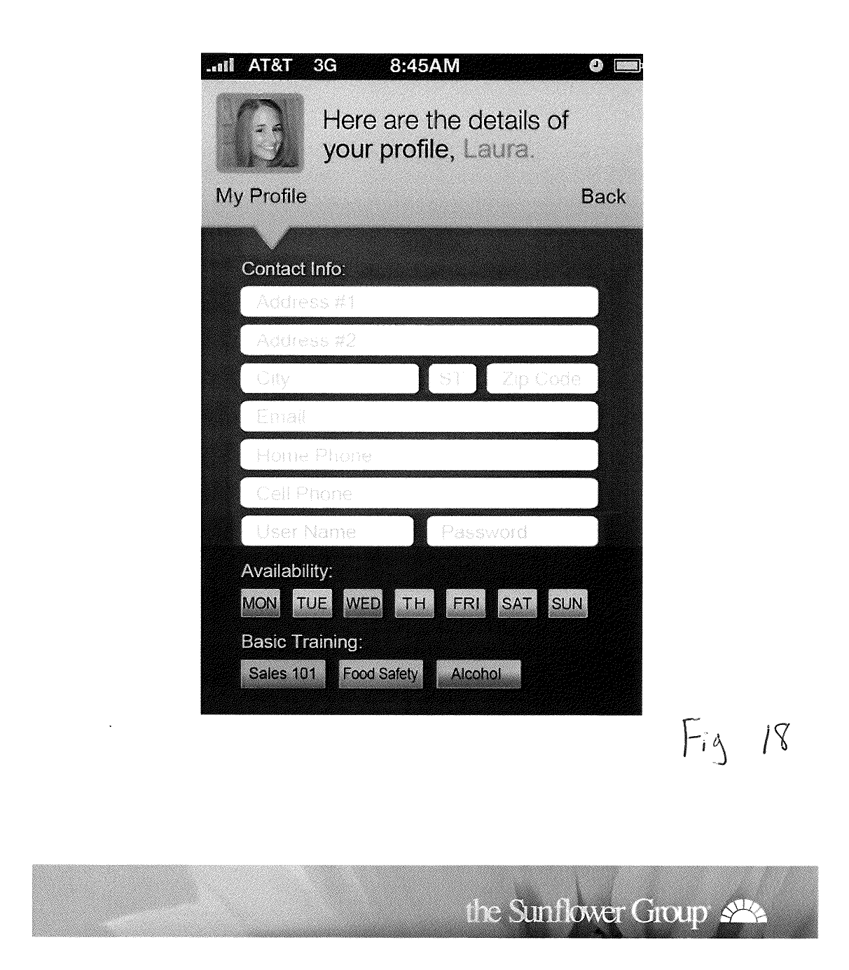

In yet another embodiment, some or all potential event personnel may have a profile page stored on or accessible by the computer system 12. Each profile page may list a person's name, cell phone number, email address, education level, skills, interests, available dates for employment, etc. The computer system may then access the profile pages for numerous potential event personnel to automatically locate event personnel most suitable for a particular event. The users may access their profile pages at any time to provide new and/or updated information. FIG. 18 shows an exemplary screen display that a user named Laura Jones may use to create her user profile.

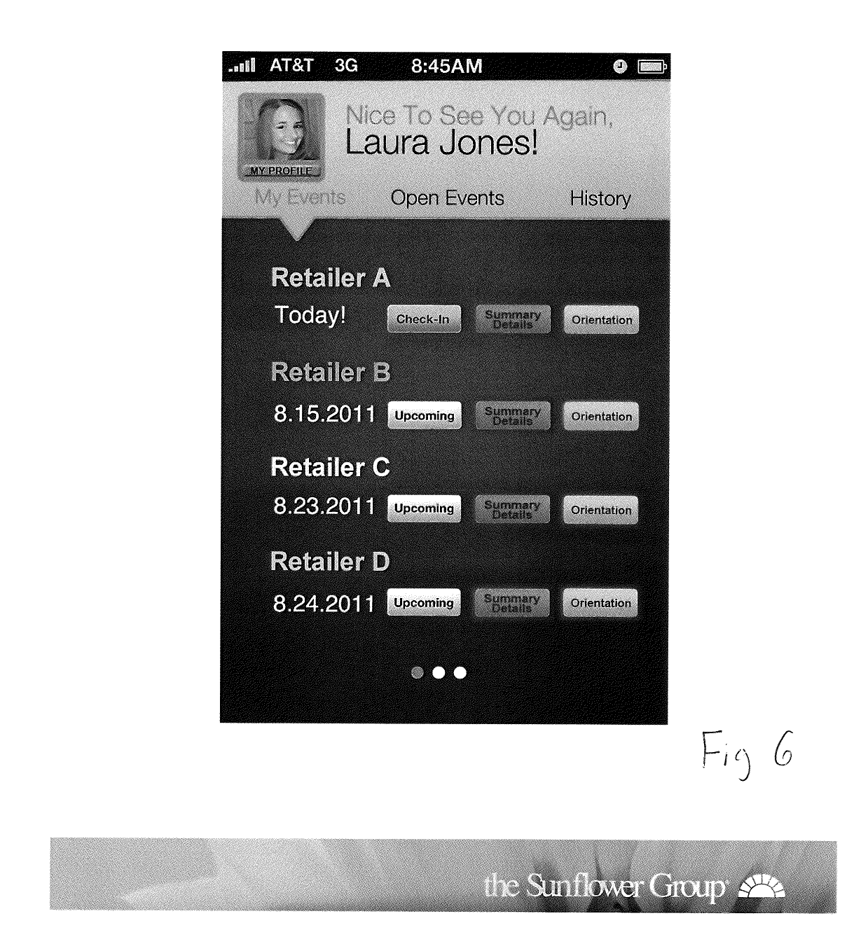

Some of the above-described steps to select event personnel for an event will now be discussed in association with exemplary screen displays that may be presented by the event management software on the portable electronic devices 20A-D. FIG. 6 shows an exemplary screen display for the account of an event personnel named Laura Jones. The page in FIG. 6 may be displayed after log-in and includes tabs for My Events, Open Events, and History. The My Events tab lists all the events Laura Jones has already agreed to staff and allows her to check-in to an event or obtain details of the event as described in more detail below. The Open Events tab lists all the events for which Laura Jones has received information but not yet agreed to staff The History tab lists all the events Laura Jones has already completed.

To register or otherwise sign-up for an event, Ms. Jones may click on the Open

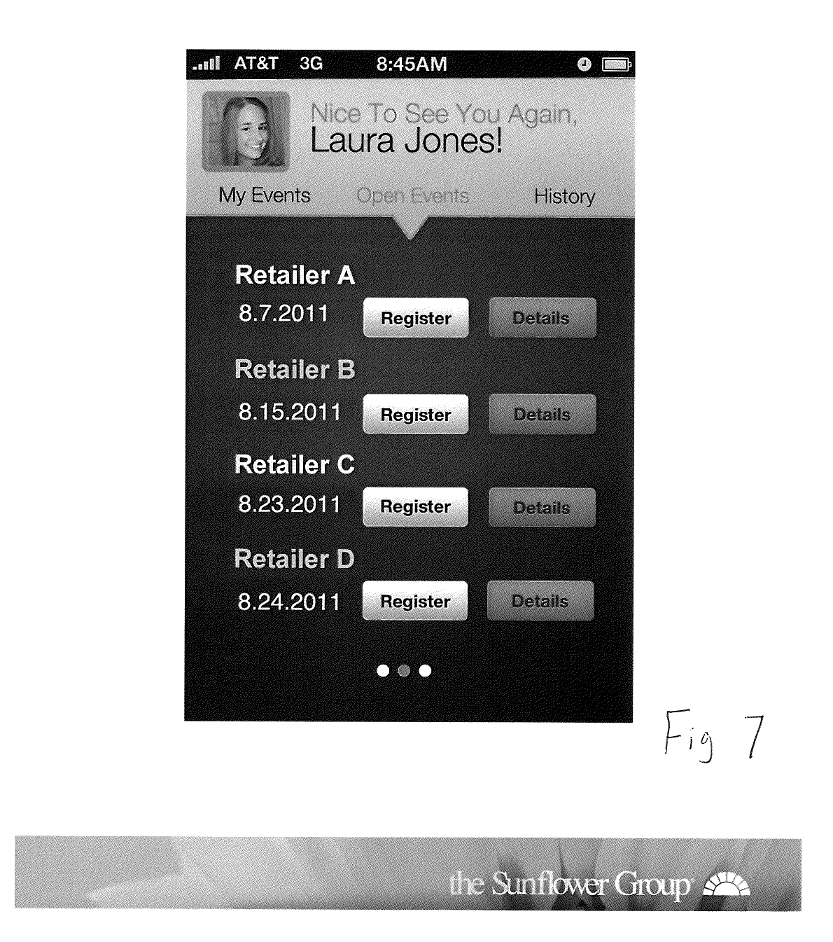

Events tabs, as shown in FIG. 7, and select an upcoming event from the event lists. She may then press an “I'm Available” button or similar button to add her name and contact information to a list of potential candidates for the event. This list may then be evaluated by the event agent to select the event personnel, or the computer system 12 may automatically accept and register the event personnel.

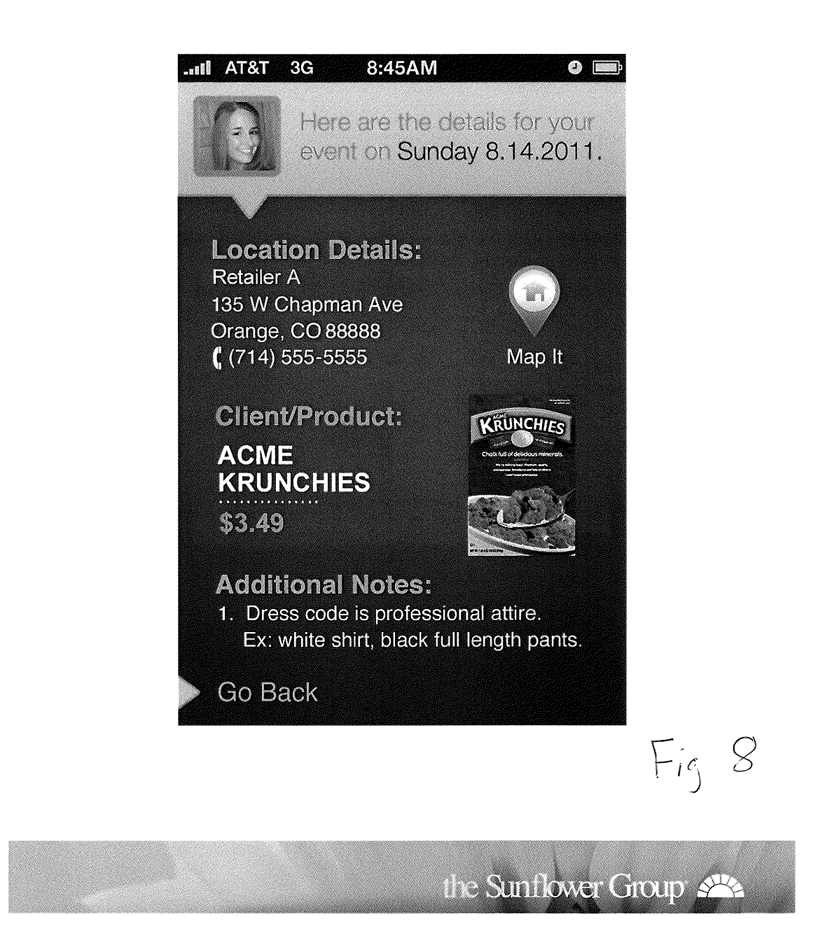

Once one or more event personnel are chosen to staff an event, more detailed information about the event is transmitted from the computer system 12 to the portable electronic devices 20A-D of the selected event personnel as depicted in step 308. The event personnel may then view the information at any time to prepare for the event. For example, an event personnel may click on the My Events tab shown in FIG. 6 to call up a list of events for which he or she has registered, select an event from the list, and then click on a Details tab or button to view details of the event. FIG. 8 shows an exemplary screen display that lists details for a product demonstration event at “Retailer A” for Acme Krunchies.

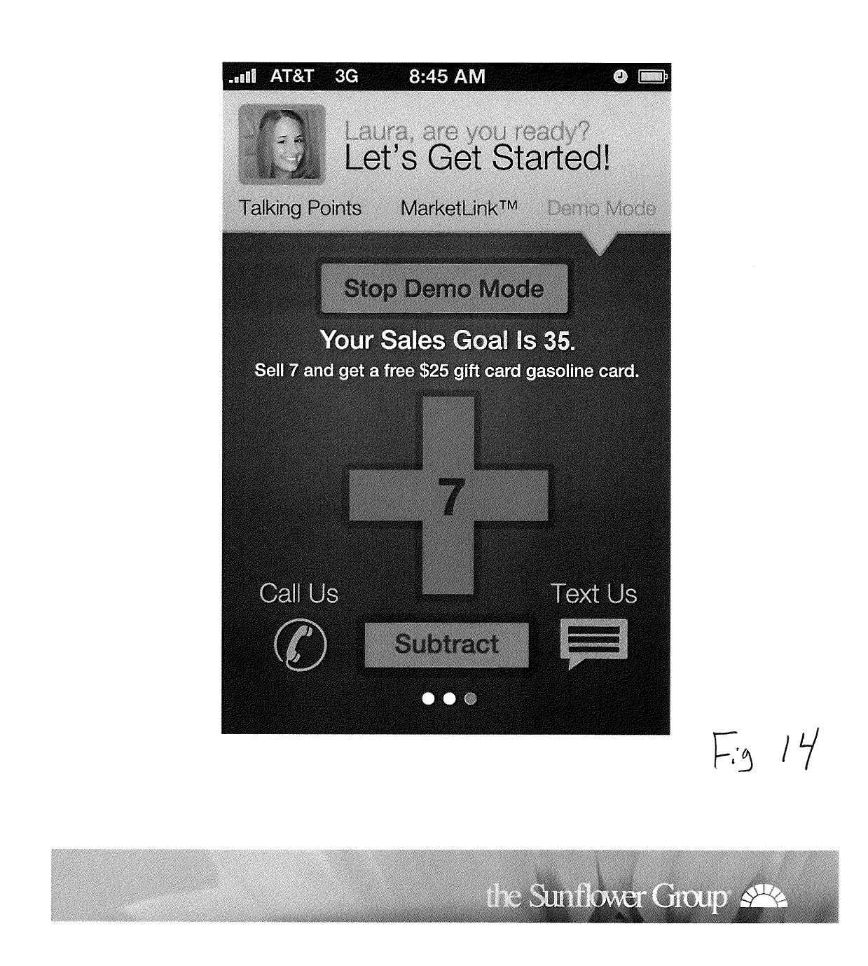

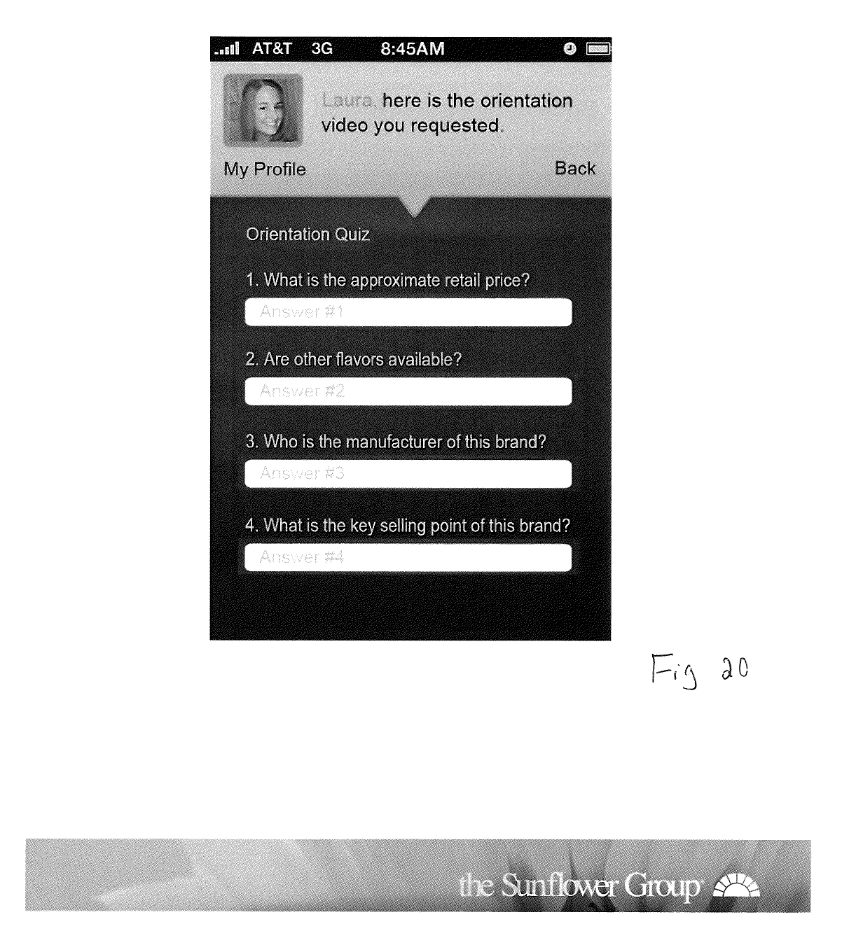

The software may also display a “Train Me” button that may be selected to direct the user to a written training manual or training video as depicted in FIG. 14. After viewing the manual or video, the software may present a number of questions the event personnel must successfully answer before being qualified to handle the event as depicted in FIG. 20.

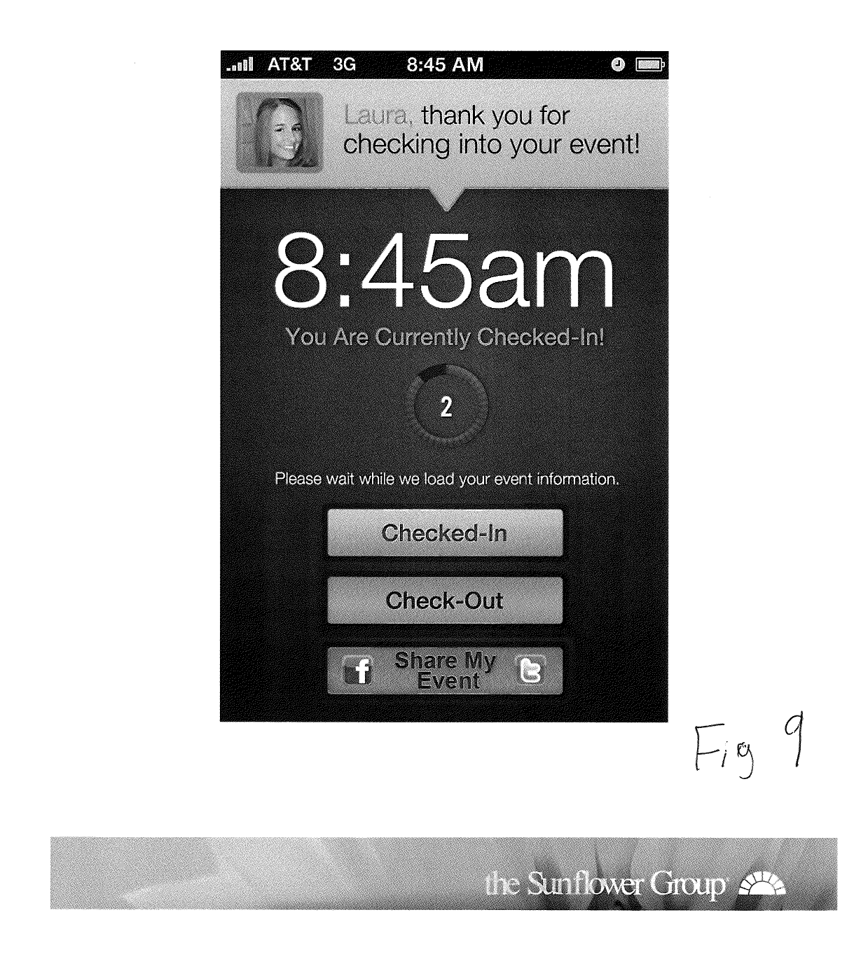

On the day of the event, the computer system 12 may broadcast a reminder to the portable electronic devices of the event personnel who are scheduled to handle the event. The event personnel then travel to the store and use their portable electronic devices 20A-D to check-in to the event as depicted in step 310. In one embodiment, this is done by selecting the event from a list or queue of events and pressing a “Check-In” button on the display of the portable electronic device. For example, the event personnel may click on the My Events tab shown in FIG. 6, select an event from the list, and then click on a “Check-In” button. This prompts the event management software to send a check-in confirmation message to the computer system 12. This may also trigger the computer system 12 to send additional event details back to the portable electronic device. The portable electronic device may then display a Check-In confirmation message such as the one shown in FIG. 9.

In accordance with one important aspect of the invention, the event management software may confirm that the event personnel is at the correct event as depicted by step 312. When each event personnel checks-in, the event management software retrieves the current location of the portable electronic device from the device's navigation receiver and compares the location to the known location of the event to confirm the event personnel is at the correct location. In another embodiment, location data for the portable electronic device may be sent to the computer system 12 so that the computer system, and/or the event agent operating the computer system, may confirm that the event personnel is at the right place.

After each event personnel checks-in, the computer system 12 may send additional instructions for the event to the portable electronic devices 20A-D as depicted in step 314. For example, the computer system 12 may send instructions for setting up a display, greeting customers, and preparing the products or services for display and demonstration.

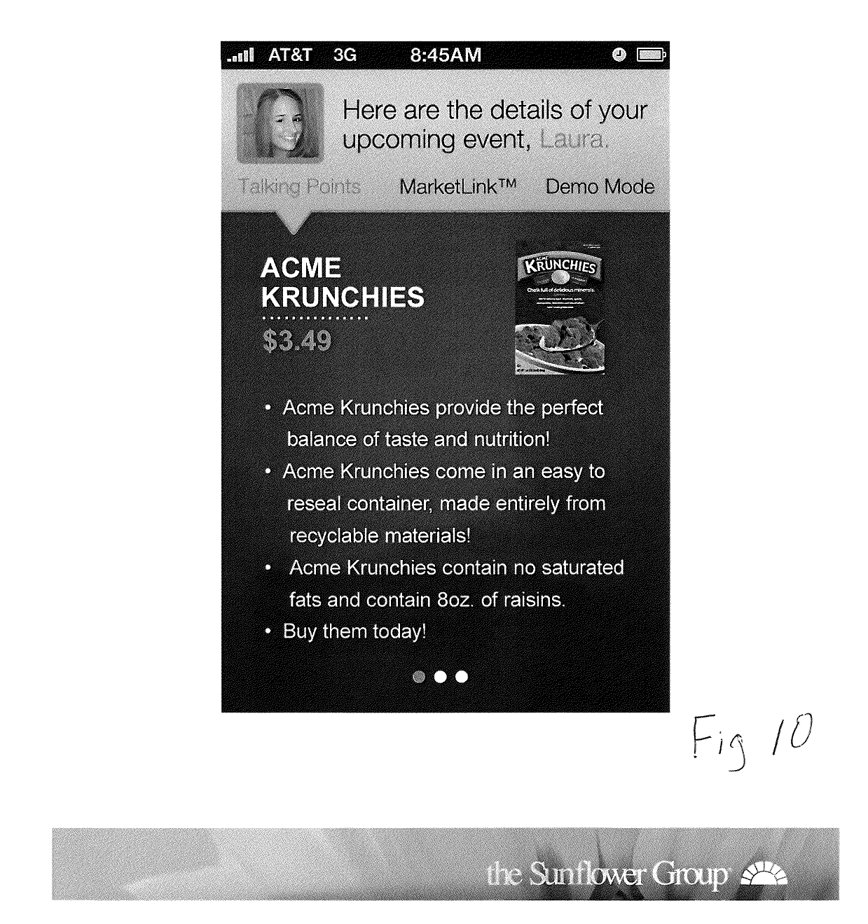

FIG. 10 shows an exemplary screen that may be displayed on the portable electronic devices after check-in. The screen includes a Talking Points tab that may be selected to view suggestions on what to say to customers during the event, a Market Link tab that may be selected to provide feedback described below, and a Demo Mode tab that may be selected when the event personnel is ready to start the event.

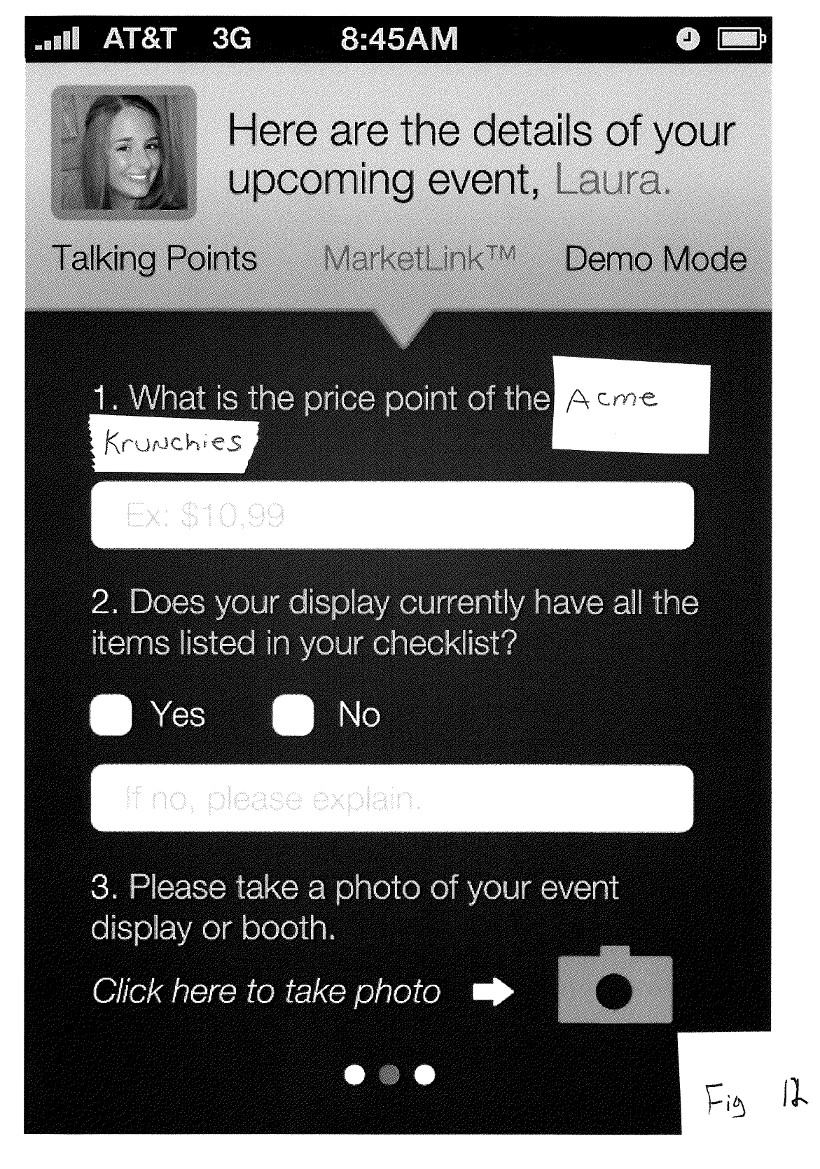

The event management software may also prompt the event personnel to provide feedback after check-in as depicted in step 316. For example, the software may prompt the event personnel to enter the price of the product being demonstrated, answer questions about the event location and/or the product in the display, and then take a photo of the display as shown in FIG. 12. The entered information and photo may then be uploaded to the computer system 12.

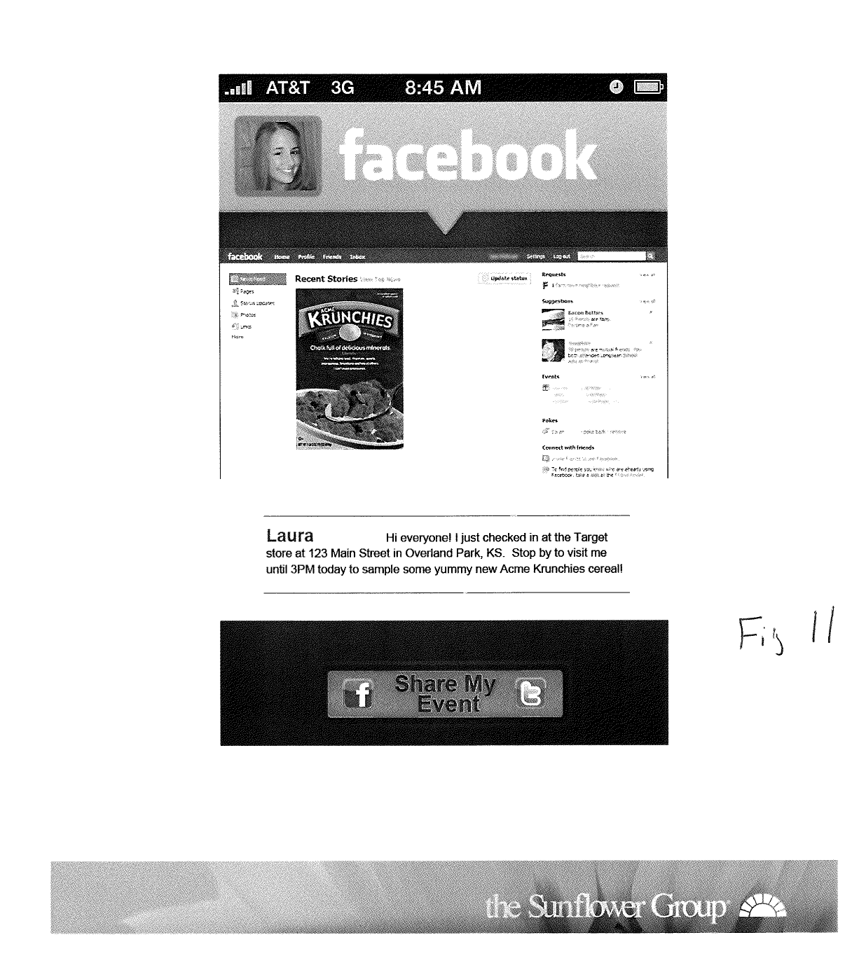

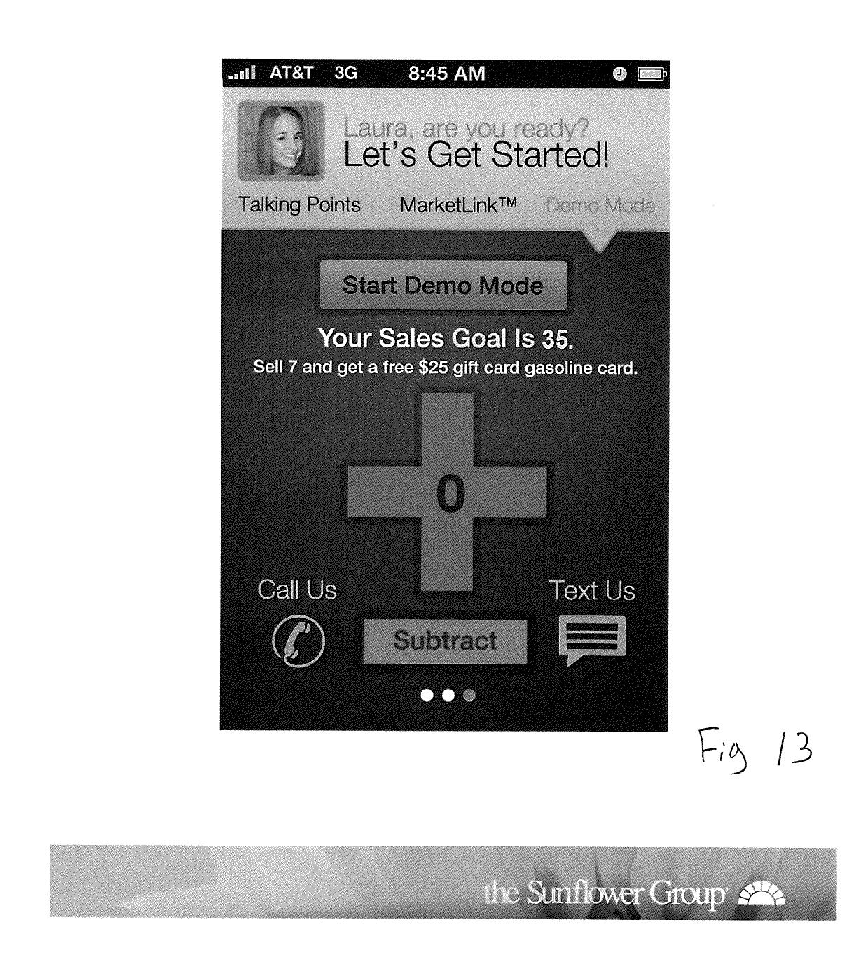

The event personnel may then begin a demonstration or event as depicted in step 318. In one embodiment, this is done by selecting a Demo Mode tab shown in FIG. 13 and then pressing a Start Demo Mode button. Before, during, or after the demonstration event, the portable electronic device may broadcast a special message about the event via the event personnels social media accounts (Facebook, Twitter, LinkedIn, etc.) The message may say, for example, “I am demonstrating XYZ Cola at 123 address at 6 p.m. today. Come see me!” An exemplary Facebook notice is shown in FIG. 11.

For example, the event personnel may be asked whether the store is busy, whether the shelves are properly stocked with the products being demonstrated, the current weather, etc. This information may be later used by the event agent or anyone else to help assess the success of the event.

The portable electronic device may then display a sales goal for the event along with an indicator of the event personnel's actual sales during the event. In the illustrated embodiment, the actual sales are shown on a large “+” sign as shown in FIG. 14. The event personnel may increment the actual sales number by pressing the “+” sign whenever he or she sees a customer take an item from a display or from a nearby store shelf. In another embodiment, the computer system 12 may receive actual sales data from the stores POS computer system 18 during the event and use this information to track the actual sales.

The computer system 12 may also broadcast the actual sales numbers to all the portable electronic devices being used to staff the same event or other similar events to create a sales competition between the event personnel.

While the event is occurring, the event management software on each portable electronic device may periodically check the device's current location and compare it to the event's location to ensure the event personnel has not left the event as shown in Step 320. Alternatively, the computer system 12 may perform some or all of these location verification steps.

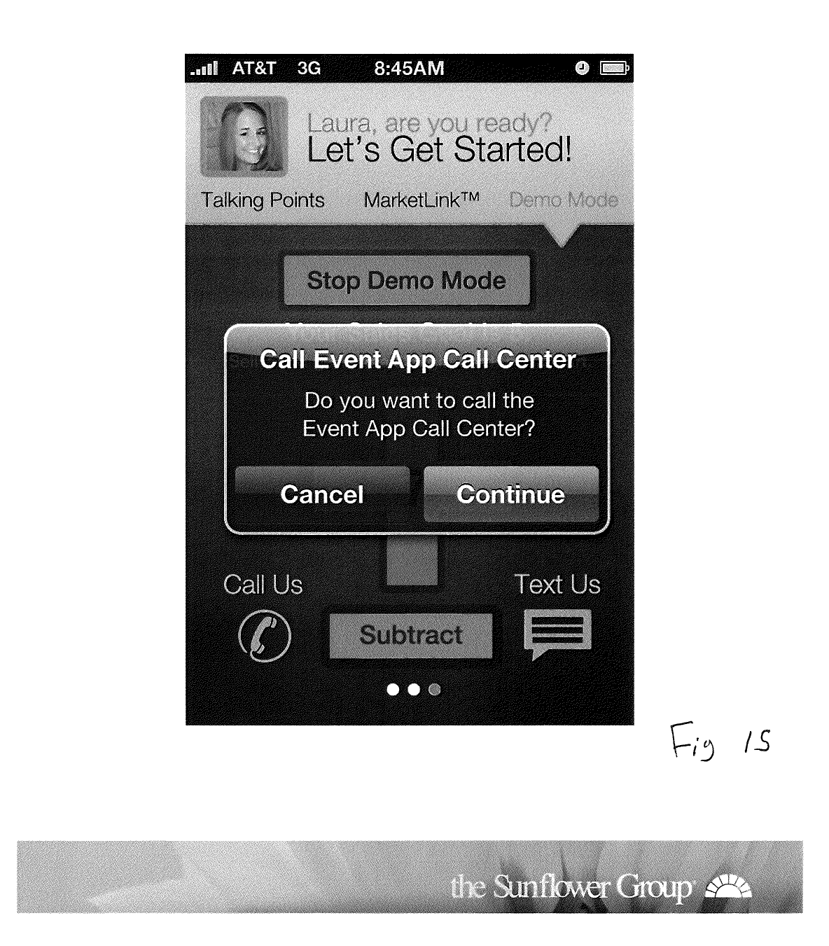

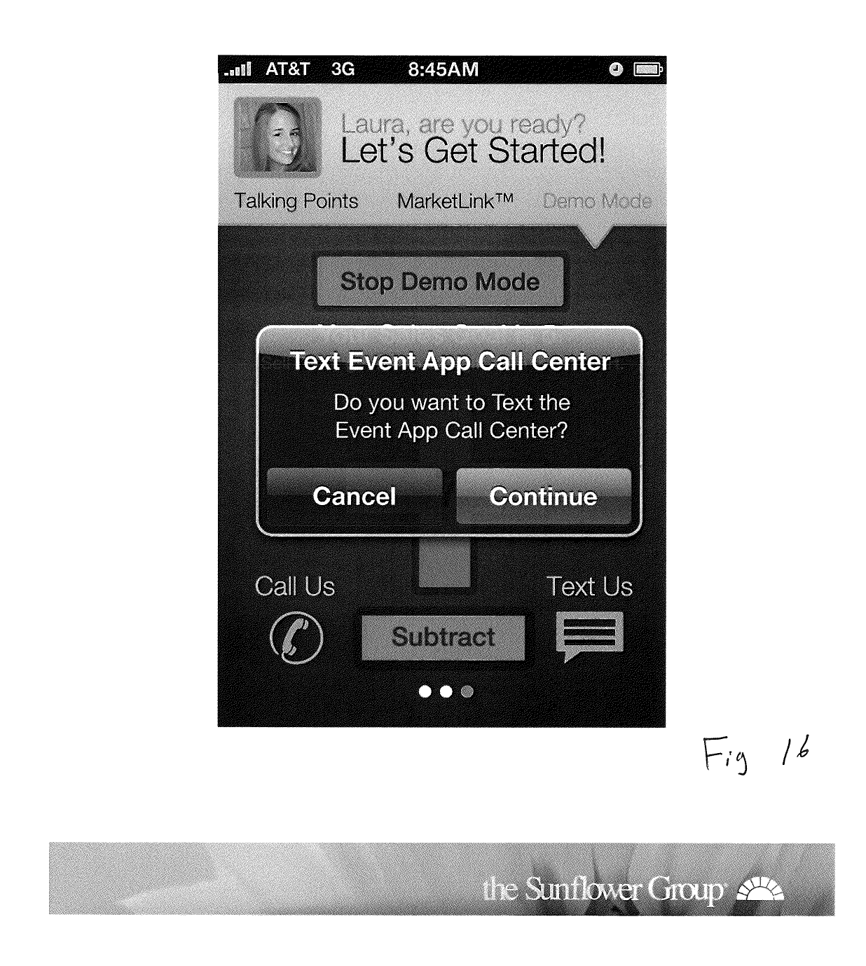

During the event, the event personnel may call or text the event agent, or a call center operated or coordinated by the event agent, by pressing a Call Us or Text Us button on the display as shown in FIGS. 15 and 16.

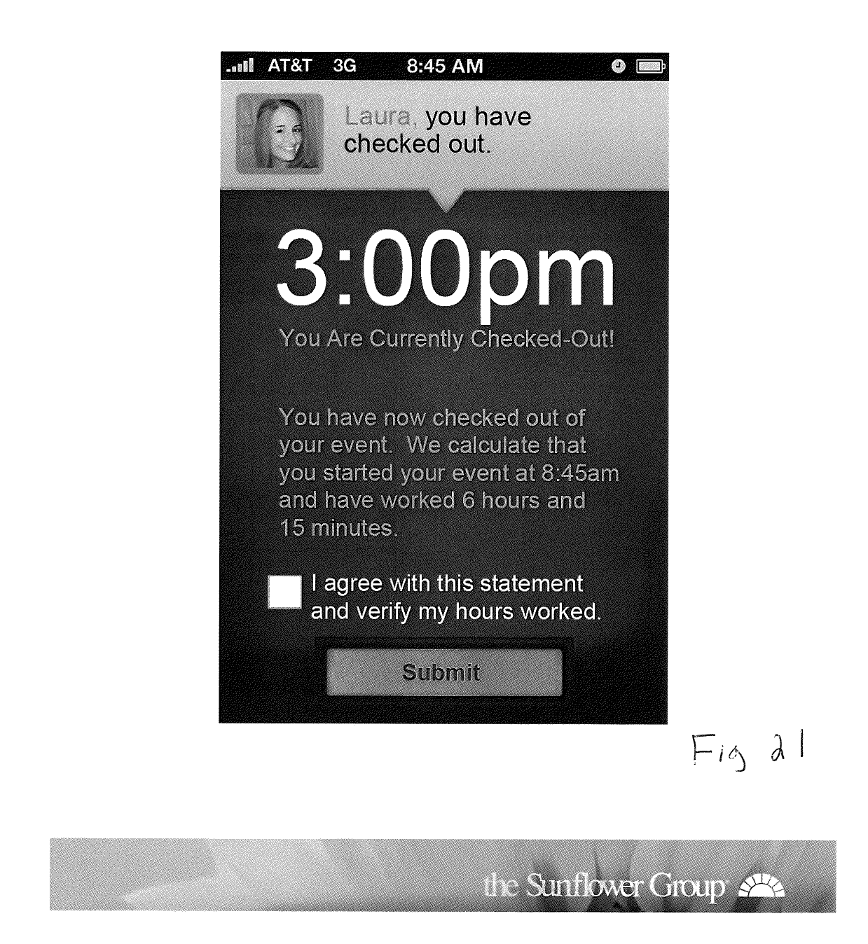

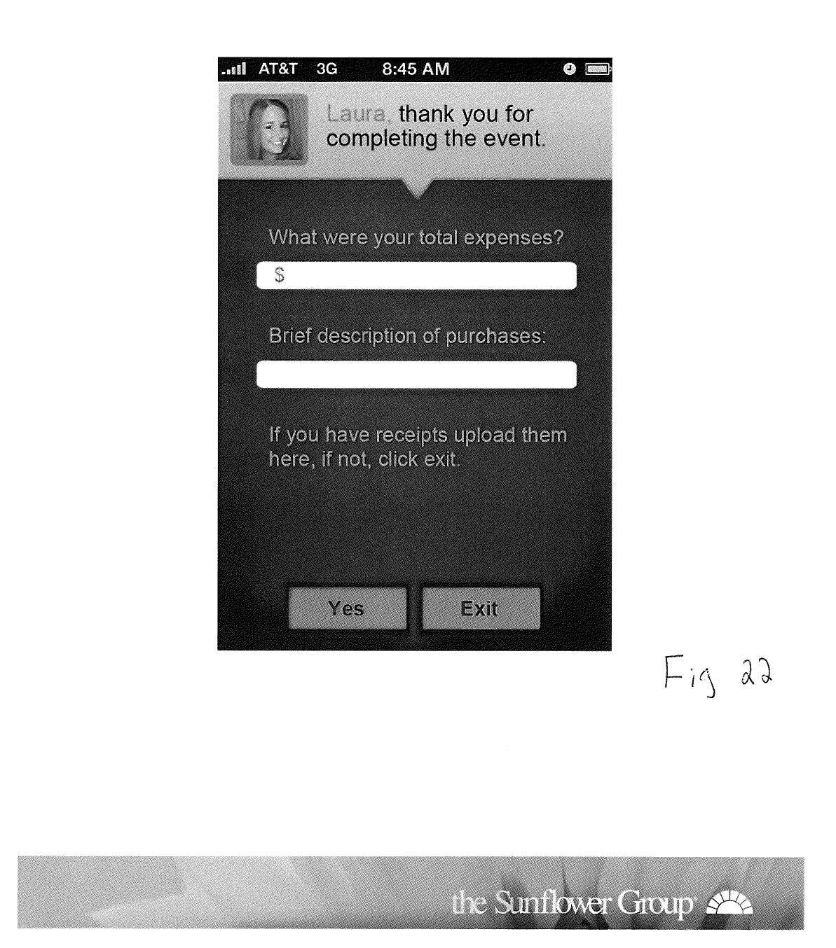

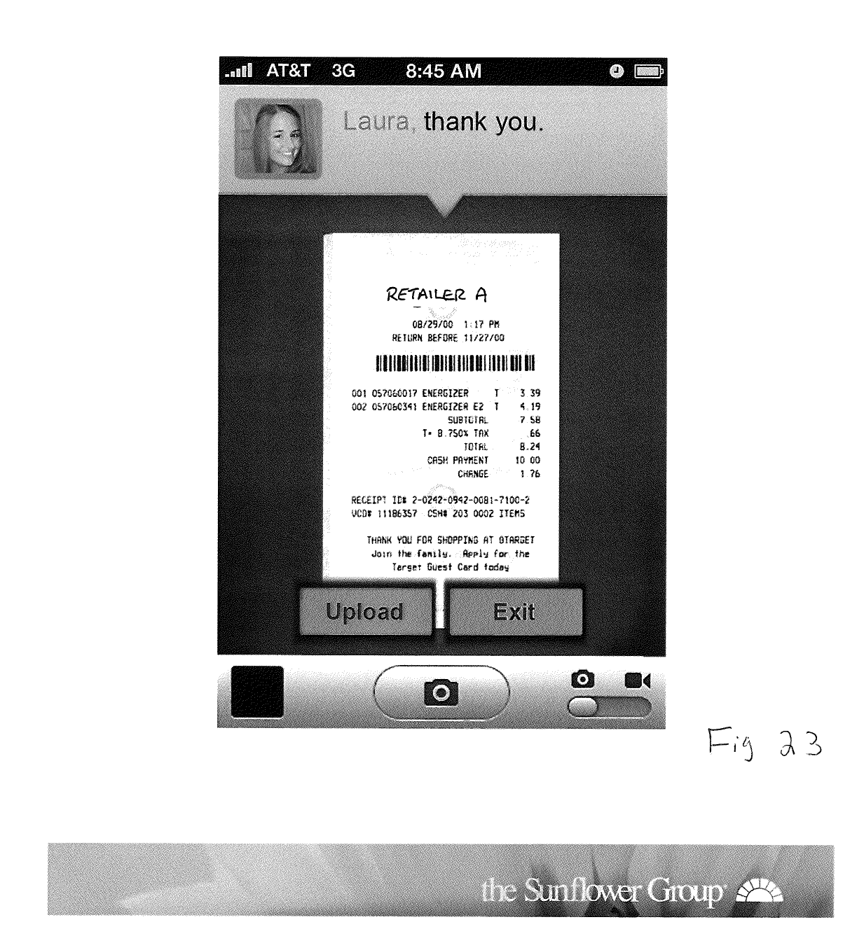

Once an event is completed, the event personnel may close the Demo Mode of the event management software as depicted by step 322 by pressing a Stop Demo Mode button shown in FIG. 14. The event management software may also calculate and/or verify the hours worked by an event personnel. In one embodiment, the software calculates the amount of time between the opening and closing of the demo Mode, displays the time, and prompts the event personnel to indicate whether he agrees or disagrees with the calculation as shown in the screen display in FIG. 21. If the event personnel agrees, the software may prompt the event personnel to indicate his or her expenses for the event as shown in FIG. 22 and take pictures of any receipts for purchased products and to upload the photos to the computer system for accounting and billing purposes as shown in FIG. 23. However, if the event personnel does not agree with the hours calculated by the software, the software may present a screen display with a phone number that may be dialed to connect with the event agent or someone else associated with the event so the discrepancy can be investigated.

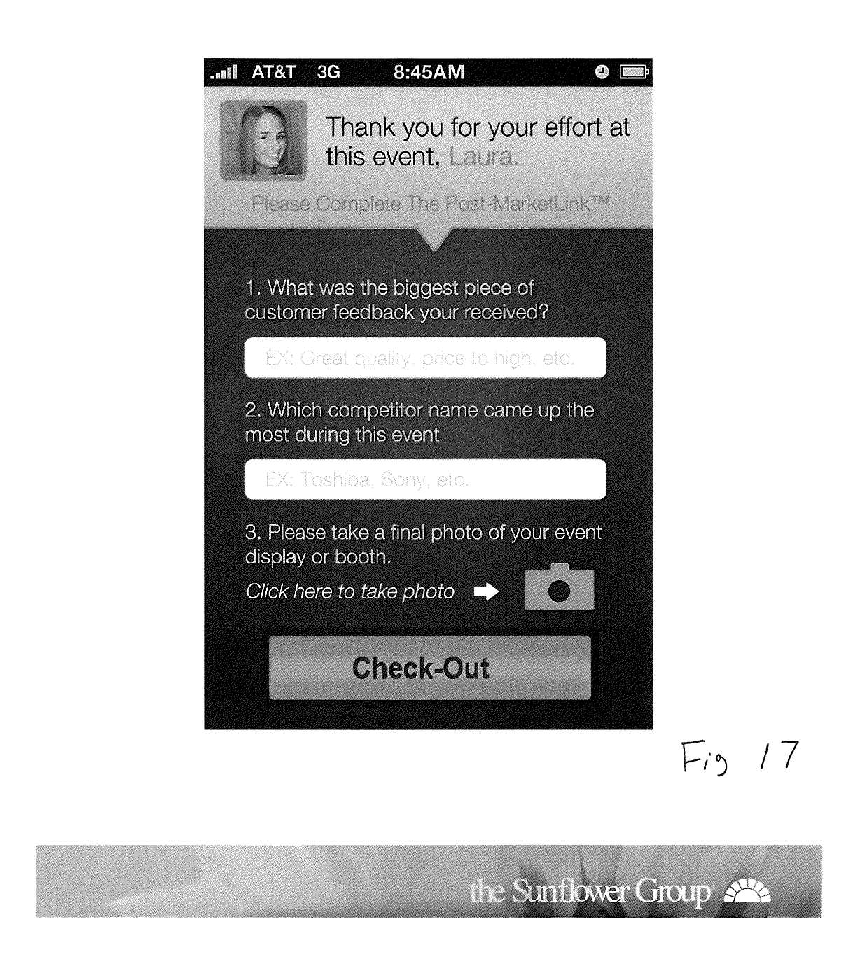

Once the event personnel has closed an event, the computer system and/or event management software may prompt the event personnel to provide post-event information as depicted in step 324. For example, the event personnel may be asked whether customers were receptive to the price of the product or service being demonstrated, what customers liked about a product or service (e.g. Favorite flavor, model, etc.), whether they ran out of stock, etc. The screen display of FIG. 17 shows an exemplary post-event questionnaire. All of the information gathered about the event by the portable electronic devices and the computer system may then be uploaded to a file or record for the event so it may be analyzed by the event agent, the product manufacturer or service provider, or the store to analyze the success of the event and to provide guidance about the products or services demonstrated.

The event management software may also manage feedback from a store manager or other person associated with the store at which the event is held. For example, the portable electronic device may prompt an event personnel to give h is or her device to a manager who is then asked to grade or otherwise rate the event personnel's performance at the demonstration event. The software may prompt the store manager to answer questions about the event personnel and/or the event and may even prompt the manager to verify the event personnel's signature or other entries. The computer program may also prompt the event personnel to take a photo of the store manager or other person.

Although the invention has been described with reference to the preferred embodiment illustrated in the attached drawing figures, it is noted that equivalents may be employed and substitutions made herein without departing from the scope of the invention as recited in the claims. For example, although embodiments of the invention work particularly well with product and service demonstration events, the invention may be used to assist with other types of events including light merchandising tasks, store audits, and secret shopper tasks. Also, although embodiments of the invention may be implemented with the computer and communications equipment described herein, the invention is not limited to this particular computer and communications equipment.

Having thus described the preferred embodiment of the invention, what is claimed as new and desired to be protected by Letters Patent includes the following:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. A computer program stored on non-transitory computer-readable medium for directing operation of a portable electronic device, the computer program comprising:
a code segment for receiving at the portable electronic device data representative of a number of events a user of the portable electronic device has agreed to staff;
a code segment for displaying on the portable electronic device an indication of the events;
a code segment for prompting the user to select and check-in to one of the events with the portable electronic device;
a code segment for receiving at and displaying on the portable electronic device details of the event to which the user checked-in;
a code segment for periodically determining a location of the portable electronic device;
a code segment for comparing the location of the portable electronic device with a location representative of the event to verify that the portable electronic device is at the event;
a code segment for prompting the user to perform an action on the portable electronic device within pre-determined time intervals to verify that the user has not left the event;
a code segment for prompting the user to take a digital photograph of a visual detail of the event to ensure that the user is at the event and has set up the event properly;
a code segment for generating a metadata time stamp of the digital photograph of the visual detail of the event; and
a code segment for displaying on the portable electronic device an indication that the user has taken the digital photograph of the visual detail of the event.

37. The computer program set forth in claim 36, further comprising a code segment for displaying on the portable electronic device pre-event and post-event questions about the event to which the user checked-in and for prompting the user to answer some of the questions before beginning the event and other questions after completing the event, wherein the questions are designed to elicit at least a portion of the following information: a beginning inventory, an ending inventory, whether a sufficient product quantity was or is available, and whether any issue regarding the event requires attention.

38. The computer program set forth in claim 36, further comprising a code segment for displaying on the portable electronic device pre-event questions about the event to which the user checked-in and for prompting the user to answer the questions before beginning the event.

39. The computer program set forth in claim 36, further comprising a code segment for displaying on the portable electronic device post-event questions about the event to which the user checked-in and for prompting the user to answer the questions after completing the event.

40. The computer program set forth in claim 36, further comprising a code segment for receiving at the portable electronic device a training video from an external source; a code segment for playing the training video on the portable electronic device; a code segment for displaying training questions on the portable electronic device after the training video has been played; and a code segment for permitting the user to staff the event if and only if a predetermined number of training questions are answered correctly.

41. The computer program set forth in claim 36, further comprising a code segment for receiving at the portable electronic device a training video from an external source.

42. The computer program set forth in claim 36, further comprising a code segment for playing a training video on the portable electronic device.

43. The computer program set forth in claim 42, further comprising a code segment for displaying training questions on the portable electronic device after the training video has been played, and prompting the user to answer the training questions.

44. The computer program set forth in claim 43, further comprising a code segment for permitting the user to staff the event if and only if a predetermined number of training questions are answered correctly.

45. A computer program stored on non-transitory computer-readable medium for directing operation of a portable electronic device, the computer program comprising:
a code segment for receiving at the portable electronic device data representative of a number of events a user of the portable electronic device has agreed to staff;
a code segment for displaying on the portable electronic device an indication of the events;
a code segment for prompting the user to select and check-in to one of the events with the portable electronic device;
a code segment for receiving at and displaying on the portable electronic device details of the event to which the user checked-in; and
a code segment for prompting the user to take a digital photograph of a visual detail of the event to ensure that the user is at the event and has set up the event properly.

46. The computer program set forth in claim 45, further comprising a code segment for displaying on the portable electronic device an indication that the user has taken the digital photograph of the visual detail of the event.

47. The computer program set forth in claim 45, further comprising a code segment for generating a metadata time stamp of the digital photograph of the visual detail of the event.

48. The computer program set forth in claim 45, further comprising a code segment for transmitting the digital photograph and the metadata time stamp to a remote computer.

49. A computer program stored on non-transitory computer-readable medium for directing operation of a portable electronic device, the computer program comprising:
a code segment for receiving at the portable electronic device data representative of a number of events a user of the portable electronic device has agreed to staff;
a code segment for displaying on the portable electronic device an indication of the events;
a code segment for prompting the user to select and check-in to one of the events with the portable electronic device;
a code segment for receiving at and displaying on the portable electronic device details of the event to which the user checked-in;
a code segment for periodically determining a location of the portable electronic device;
a code segment for comparing the location of the portable electronic device with a location representative of the event to verify that the portable electronic device is at the event; and
a code segment for prompting the user to perform an action on the portable electronic device within pre-determined time intervals to verify that the user has not left the event.

50. The computer program set forth in claim 49, further comprising a code segment for transmitting to a remote computer an indication that the portable electronic device is not at the event or that the location of the portable electronic device could not be determined, and a code segment for transmitting to the remote computer an indication that the user has not performed an action on the portable electronic device within one of the pre-determined time intervals.

51. The computer program set forth in claim 49, wherein the code segment for determining the location of the portable electronic device utilizes a global positioning system (GPS).
